(19) United States
(12) Patent Application Publication
(10) Pub. No.: US 2006/0167609 A1
(43) Pub. Date: Jul. 27, 2006

(54) Industrial truck

(75) Inventors: Francois Brouart, Margny las compiagn (FR); Paulo Ferreira, Rieux (FR); Daniel Krupka, Cambronne (FR); Lars Gunther, Rheine (DE); Torsten Leifert, Vogelsen (DE)

Correspondence Address: THE WEBB LAW FIRM, P.C., 700 KOPPERS BUILDING, 436 SEVENTH AVENUE, PITTSBURGH, PA, 15219, US

(73) Assignees: STILL GmbH, Hamburg (DE); STILL S.A.R.L, Meaux Cedex (FR)

(21) Appl. No.: 10/865,502

(22) Filed: Jun. 10, 2004

(30) Foreign Application Priority Data
Jun. 11, 2003 (DE) 103 26 309.8

(51) Int. Cl. G06F 19/00

(52) U.S. Cl. 701/50

(57) ABSTRACT

The invention relates to an industrial truck with an on-board energy reservoir (1) and at least one drive system (2) supplied with energy from it. On the industrial truck there is a device (4) to display the remaining operating time.

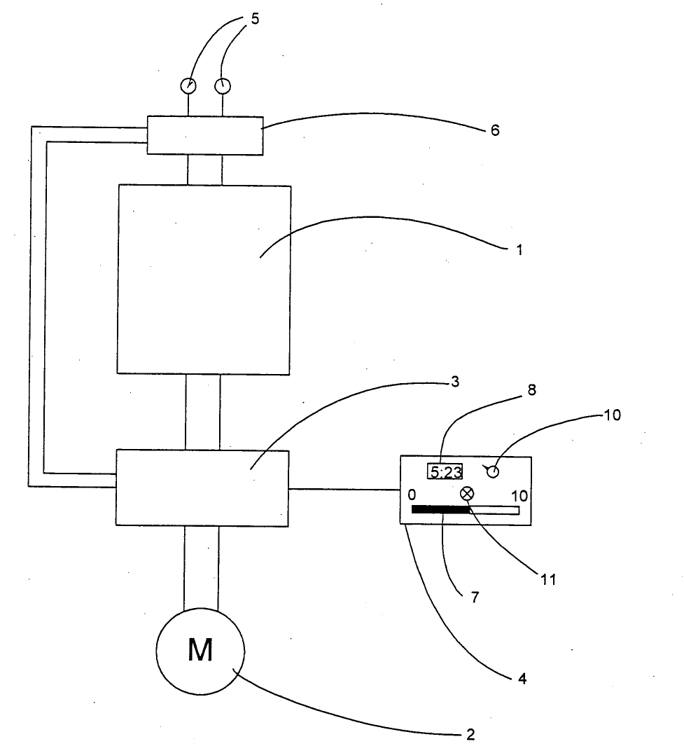

### CROSS REFERENCE TO RELATED APPLICATION

This application corresponds to German Application No. 103 26 309.8 filed Jun. 11, 2003, which is herein incorporated by reference in its entirety.

### BACKGROUND OF THE INVENTION

1. Field of the Invention

This invention relates to an industrial truck with an on-board energy reservoir and at least one drive that is supplied with energy from the energy reservoir.

2. Technical Considerations

Industrial trucks of this type exist in a variety of configurations, for example, in the form of fork-lift trucks or lift trucks with an electrical or internal combustion drive system, and with an energy reservoir in the form of a battery or a tank for liquid and/or gas fuels. The energy from the energy reservoir can be converted directly in the drive system, for example, in an electric motor drive system which is powered from a battery, or transformed by means of an intermediate step, for example, in a fuel cell system or with the operation of a generator for the generation of electrical energy.

When the energy supply has been exhausted, it is frequently impossible to move the industrial truck because, in that case, the vehicle braking devices are typically actuated automatically. Consequently, it is difficult, complex, and time-consuming to supplement the energy supply. Many energy reservoirs, such as batteries, for example, are also damaged if they are fully discharged. The total discharge of the energy reservoir must, therefore, be absolutely avoided during operation, which means that it is important for the operator to know as accurately as possible the amount of energy that remains in the energy reservoir. In tanks that contain liquid fuel, a level indicator is generally used, and a charge capacity indicator is generally used with batteries. But because an indicator of this type only displays the energy in the storage device, an operator, especially if he or she is not very familiar with the industrial truck and the operating requirements, often finds it difficult to estimate whether the energy supply is sufficient to perform a defined transport task, for example, or to operate the industrial truck until the end of a shift without supplementing the fuel supply. On battery-operated trucks in particular, the display of the remaining capacity is generally indicated in relation to the fully charged capacity and, therefore, the same reading can indicate different quantities of energy if one battery is replaced with a different type of battery.

Therefore, it is an object of the invention to provide an industrial truck that makes it possible for an operator to easily and reliably estimate the operational capabilities of the industrial truck until the energy that remains in the energy reservoir is exhausted.

### SUMMARY OF THE INVENTION

The invention teaches that a device is provided to display the remaining operating time. An indication of time is much easier for an operator to understand than an indication of the amount of energy. For example, the operator can estimate correctly whether the supply of energy will last until the shift change or until the end of the current operation. Inexperienced operators, in particular, who are not familiar with the capacity of the energy source and the energy consumption of the industrial truck can thereby make reliable plans for the use of the industrial truck.

It is advantageous if the remaining operating time is indicated by an analog display, in particular by a bar diagram or a pointer display. Analog displays can be read particularly quickly and, therefore, do not distract the operator for an unnecessarily long period of time.

In one advantageous configuration of the invention, the remaining operating time is indicated by a digital display, such as in terms of hours and/or minutes. This configuration makes possible a particularly accurate indication of the remaining operating time.

It is particularly advantageous if the remaining operating time to be indicated can be calculated from the content of the energy storage mechanism and the average power that is extracted during a determined or selected period of time. The power that is required during the typical operation of the industrial truck is thereby used as the basis for the indication of the operating time.

In one advantageous configuration, the length of time for the calculation of the average power extracted can include several hours to several days (for example, 2 hours to 10 days, such as 2 hours to 5 days, such as 2 hours to 3 days), and also can include both operating times and non-operating times. The result is a particularly accurate indication for longer-term operation because the typical operation of the industrial truck is used as the basis for the indication taking into consideration periods of reduced activity and times the industrial truck is not operating.

In one additional advantageous configuration, the length of time used to calculate the average power extracted is less than one hour, such as the most recent 2 minutes, and only operating times of the industrial truck are taken into consideration. Because the period is relatively short and only the time that the industrial truck is actually being operated is taken into consideration, the operator knows how long the industrial truck can still be operated under the current operating conditions.

It is particularly advantageous if the length of time that is used for the averaging of the power extracted can be varied. It is thereby possible to adapt the length of this time to the conditions under which the industrial truck is being operated.

It is also advantageous if the remaining operating time to be displayed can be calculated from the content of the energy reservoir and the maximum power that can be extracted from the energy reservoir. This method makes it possible to estimate the minimum operating time that is also guaranteed even when the industrial truck is operating under the maximum load.

In one advantageous configuration of the invention, the remaining operating time to be indicated can be calculated from the contents of the energy reservoir and an energy consumption that is determined for the industrial truck under typical or standardized operating conditions. If the industrial truck is consistently operated under these conditions, it becomes possible to easily and accurately predict the remaining operating time.

It is particularly advantageous if the method used to calculate the remaining operating time can be selected by the operator. It thereby becomes possible to adapt the method of calculation to the requirements of the individual operator.

It is further advantageous if the method of calculation of the remaining operating time can be changed as a function of the operating conditions. It is thereby possible to select a calculation method that is most appropriate to the current operating conditions, as a result of which a more accurate display of the remaining operating time is achieved.

In addition to or as an alternative to the remaining operating time, the remaining distance the industrial truck can travel can also be indicated. On industrial trucks that are used primarily for transport tasks and seldom lift loads, for example, the indication of the remaining range is an important piece of information for the operator, so that the industrial truck can be returned to a charging station, for example.

It is advantageous if an alarm signal can be triggered when the remaining operating time falls below a specified threshold. The operator is thereby warned before the energy in the energy reservoir is exhausted and can take prompt measures to supplement the energy supply.

In one advantageous realization of the invention, the energy reservoir is a battery. Batteries are widely used energy sources on industrial trucks that have a simple energy supply system. The energy contained in the reservoir and the quantity of energy added and extracted can be determined easily and accurately.

In an additional advantageous configuration, the energy reservoir is a tank for liquid and/or gas fuels. The operation of industrial trucks with liquid or gas fuels is widespread and does not require a complex or expensive infrastructure.

### BRIEF DESCRIPTION OF THE DRAWING

Additional advantages and details of the invention are explained in greater detail below with reference to the exemplary embodiment illustrated in the accompanying schematic FIGURE. The FIGURE shows a schematic circuit diagram for an industrial truck with an energy reservoir realized in the form of a battery 1, a drive system realized in the form of an electric motor 2, and an electronic control unit 3 that is effectively connected with a display unit 4. Additional typical components of an industrial truck of the known art, such as control elements, additional drive systems, electrical consumers and sensors, for example, which are not necessary for an understanding of the exemplary embodiment of the invention are not shown in the drawing.

### DESCRIPTION OF THE PREFERRED EMBODIMENT

As shown in the FIGURE, the battery 1 can be supplied with electrical energy either by means of the connection terminals 5 for a conventional charging unit (not shown here), or with the energy recovered from the electric motor 2. The charging status of the battery 1 is monitored by means of the control unit 3. For example, the quantity of energy supplied by a charging unit can be determined by means of a measuring device 6. The energy supplied to the electric motor 2 or generated by the electric motor 2 and returned to the battery 1 is also measured in the control unit 3, for example, by measuring the current between the battery 1 and the electric motor 2. The charging status of the battery 1 is thereby always known. Of course, other conventional methods and devices of the known art can also be used to determine the charging status of the battery 1.

By measuring the current between the battery 1 and the electric motor 2, the power output can also be determined and, from that value, the average power absorbed by the electric motor 2 over a determined period of time can be calculated. If the period in question is relatively long, for example days or weeks, but at least a few hours, for example one operating shift, the power requirement of the industrial truck during its typical spectrum of tasks can be determined quite accurately. This method also makes it possible to take the typical pauses in operation into consideration. The quotient of the average power consumption and energy content of the energy reservoir 1 thereby directly indicates the remaining operating time at the power consumption in question. The remaining operating time can be transmitted to the operator in the display unit 4. The time can be displayed in a number of different ways, e.g., acoustically by a warning tone, or in the form of speech; although in this exemplary embodiment there is an optical display 7 which represents the remaining operating time in the form of a bar diagram. The optical indicator 7 does not distract the operator from his or her work and can be read quickly. Other conventional types of displays could also be used, for example, a dial or a series of LEDs of the same or different colors are also conceivable. Although displays of those types are easy to read, they are not highly accurate. In addition, therefore, a digital display 8 can be provided which indicates the remaining operating time in hours and minutes. A device of the type that is already provided to display other values can also be used, which the operator can switch to the desired time display when needed.

If the length of time used to average the power consumed by the electric motor 2 is relatively short, for example, in the range of a few minutes up to an hour (e.g., in the range of 1 minute to 1 hour), the calculated remaining operating time indicates the length of time the industrial truck can continue to be operated at the current load. This information is particularly helpful if the load on the industrial truck changes frequently, because it allows the operator to determine accurately how long the industrial truck can still be operated under the load just carried. In particular, when the calculation is based on a short period of time, preferably only the operating times and not the non-operating times of the industrial truck are taken into consideration, because in that way the remaining time for continuous operation can be determined.

The length of time for the averaging of the power absorbed by the electric motor 2 can be varied. This setting can be made by a service technician when maintenance is being performed on the industrial truck, although embodiments are also possible in which this action can be performed by the operator by means of a control component. It is thereby possible to adjust the length of time to the typical operating conditions of the industrial truck. If the operation includes relatively long phases of alternating heavy-duty and light-duty loads, the average taken over a period that includes both phases can lead to an overestimation of the remaining operating time if the loads exerted turn out to be higher.

An additional possible method that can be used to calculate the remaining operating time is to form a quotient from the maximum possible power consumption of the industrial truck and divide by the energy content of the energy reservoir 1. This method determines the remaining operating time during continuous operation at the maximum possible load and thereby indicates the shortest possible remaining operating time. Because the maximum load in practice is not in the form of continuous operation, with this calculation method there is still a sufficient safety margin for the operation of the industrial truck when the display signals that the operating time is at an end.

In an additional embodiment, the remaining operating time can be calculated as the quotient of a power consumption for the industrial truck determined under typical or standardized operating conditions. This power consumption can be determined in tests by the manufacturer, for example, or in test operation at the point of use. With this method, because in this realization there is no determination of the current that flows from the battery 1 to the electric motor 2 and, thus, no calculation of the average power is necessary, the remaining operating time to be indicated can be determined relatively simply. This method can also be used effectively even after the industrial truck has been out of operation for long periods of time to obtain an estimate of the remaining operating time, if there is reason to assume that the operating conditions have changed.

In this exemplary embodiment, the operator can use a switch 10 to select the method used to calculate the remaining operating time. The operator can, therefore, use the method that is best suited to the current operating conditions and his or her own requirements. The switch can be made at any time, for example, to compare the results of the different methods. An indication of the method selected, for example, by the position of the switch 10 or a presentation in the display unit 4, makes it possible to see at any time how the remaining operating time is being calculated. It is also possible to change the method of calculation automatically depending on the operating status. After a long period during which the industrial truck has been out of operation, for example, a calculation can be made on the basis of typical or standardized operating conditions, because it can be assumed that the operating conditions have changed. After a certain period of operation, the method can be switched to a calculation based on the average actual power consumption of the drive system 2. The period of time used for the averaging can thereby also be adjusted automatically and, for example, during longer phases of high power consumption, which are also interrupted by relatively long pauses, can be selected so that the pauses are not taken into consideration, to make certain that the indications 7, 8 during the phases of high power consumption do not indicate excessive values for the remaining operating time.

The operator can be notified by a warning signal that the remaining operating time has fallen below a specified length of time. In this exemplary embodiment, a warning light 11 can be provided in the display unit, although other realizations of the known art can also be used, such as, for example, an acoustical signal or a reference to a display screen.

Of course, other realizations of the industrial truck of the invention are also possible, for example, with an internal combustion engine that is effectively connected directly with a traction drive system or supplies electrical or hydraulic energy for traction and/or lifting drive systems. Another possibility is the use of a fuel cell system which obtains its energy from a tank containing hydrogen or methanol, for example. In a system that uses liquid or gas fuels, the energy content of the tank can be determined, for example, by means of a level measurement and the energy extracted by the measurement of the quantity of fuel extracted. When the fuel is transformed into electrical energy, it is also conceivable that the current supplied can be measured. If different fuels are used, an adaptation must be made to the different specific energy content of the different fuels. On an industrial truck that does not have a lift drive system powered from the energy reservoir or on which the lift device is rarely used because the industrial truck is used primarily for towing, for example, alternatively or in addition to the indication of the remaining operating time, the remaining operating range can be indicated. For that purpose, the distance and the average speed can be calculated by means of speed sensors on a drive motor or on a drive wheel or on another wheel of the industrial truck, and the product of the average speed and the remaining operating time can be indicated as the remaining range.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An industrial truck, comprising:
an on-board energy reservoir;
at least one drive system that is supplied with energy from the energy reservoir; and
a device to indicate the remaining operating time of the industrial truck based on the energy reservoir.

2. The industrial truck as claimed in claim 1, wherein the remaining operating time is indicated by an analog indicator.

3. The industrial truck as claimed in claim 1, wherein the remaining operating time is displayed by a digital display.

4. The industrial truck as claimed in claim 1, wherein the remaining operating time to be displayed is calculated from the content of the energy reservoir and the average power extracted during a selected period of time.

5. The industrial truck as claimed in claim 4, wherein the length of time for the calculation of the average power extracted is in the range of two hours to three days and takes both operating times and non-operating times into consideration.

6. The industrial truck as claimed in claim 4, wherein the length of time for the calculation of the average power extracted is less than one hour and takes into consideration only times the industrial truck is in operation.

7. The industrial truck as claimed in claim 1, wherein the length of time that is used for calculating the power extracted is variable.

8. The industrial truck as claimed in claim 1, wherein the remaining operating time to be displayed is calculated from the content of the energy reservoir and the maximum power that can be extracted from the energy reservoir.

9. The industrial truck as claimed in claim 1, wherein the remaining operating time to be displayed is calculated from the content of the energy reservoir and a predetermined energy consumption that has been determined for the industrial truck under typical or standardized operating conditions.

10. The industrial truck as claimed in claim 1, wherein the method used to calculate the remaining operating time is selectable by an operator.

11. The industrial truck as claimed in claim 1, wherein the method used to calculate the remaining operating time is variable as a function of an operating status of the industrial truck.

12. The industrial truck as claimed in claim 1, wherein in addition to or as an alternative to the remaining operating time, the remaining operating range can be indicated.

13. The industrial truck as claimed in claim 1, including a warning signal triggered when the remaining operating time falls below a predefined threshold.

14. The industrial truck as claimed in claim 1, wherein the energy reservoir includes a battery.

15. The industrial truck as claimed in claim 1, wherein the energy reservoir includes a tank for liquid or gas fuels.

16. The industrial truck as claimed in claim 2, wherein the analog indicator is selected from a bar indicator or a pointer display.

17. The industrial truck as claimed in claim 3, wherein the remaining operating time is displayed in units of hours and minutes.

18. The industrial truck as claimed in claim 6, wherein the length of time for the calculation of the average power extracted is less than or equal to two minutes.
